(19) United States
(12) Patent Application Publication
(10) Pub. No.: US 2003/0160708 A1
(43) Pub. Date: Aug. 28, 2003

(54) Airport ground control system

(76) Inventor: Alan Richard Knoop, Richmond, VA (US)

Correspondence Address: JOHN H. THOMAS, P.C., 1561 EAST MAIN STREET, RICHMOND, VA, 23219, US

(21) Appl. No.: 10/083,813

(22) Filed: Feb. 27, 2002

(51) Int. Cl. G08B 21/00

(52) U.S. Cl. 340/958; 340/909; 701/117

(57) ABSTRACT

An airport ground control system controls the movement of vehicles over a network of pathways and intersections that make up the airport. The system includes detectors, directional signals and a programable logic controller. The programable logic controller directs the route of vehicles based on input from a control touch screen video monitor, the detectors and output to the directional signals. The specific route selection is determined by progressive solution logic.

The present invention relates to an efficient and reliable system for controlling the safe operation of ground equipment at airports. The coordinated system described herein uses progressive solution logic to direct ground traffic and essentially remove the danger of human error in guiding that traffic.

### BACKGROUND OF THE INVENTION

The operation of aircraft and vehicles on the ground at airports has always been a visual matter since an airport is an open space with a few depressions or crowns in the general layout. Control of traffic is by radio employing a person located in an elevated control tower. These ground controllers have a good general view of the entire airport and can direct traffic visually.

In periods of good weather and light traffic, this method of operation is used effectively. However, as traffic has increased and as operations currently proceed in all conditions of weather, the ground controller does not always have a good view of the airport or the equipment under his control. Furthermore, the size of airports has grown considerably and visual control can be limited so that dangerous conditions can be allowed to arise.

When there is multiple aircraft traveling to various locations at a busy airport, the pilots themselves have a difficult time watching for other aircraft as they travel. When an aircraft is taxiing out to a runway for take off, the flight crew is occupied making checks of the operation of the aircraft and is not always aware of other approaching aircraft. As a result there have been collisions of aircraft on the ground resulting in loss of life due to conflicting paths. Conflicting paths or routes are those in which moving aircraft and/or vehicles are authorized to occupy the same space at the same time, or there is the potential for this condition. Far more frequently than major collisions there are “near misses” or minor contact between aircraft that result in damage to equipment and at times operations delay because an aircraft has run off a taxiway to avoid collision.

Accidents involving loss of life have occurred because aircraft have used a closed or occupied taxiway. This can be caused by improper instructions from the ground controller, pilot error in determining actual aircraft position, or weather conditions, which do not allow pilots to orient themselves with respect to signs or other airport facilities.

In addition to aircraft, there are always a number of service vehicles that traverse the airport, serving multiple functions. These vehicles are an additional risk factor to all moving ground traffic. In general it is the responsibility of the vehicle driver to keep clear of other vehicles and aircraft. However, due to the open nature of the airport, traffic can be approaching a vehicle from any direction and it is difficult for a driver to stay clear of all approaching traffic. Collisions between vehicles and between vehicles and aircraft do occur, resulting in personal injuries, damage, and traffic delays.

There are also instances where emergency vehicles must move around the airport. These vehicles require priority to go promptly to their assigned destination. Again, they operate on a visual basis with contact to the ground control by radio. Emergency vehicles are distinguished by flashing lights and audible signals. However, there are so many lights of various colors and flashing rates at airports that lights alone cannot be relied upon to provide knowledge of the location of true emergency vehicles.

Current Operation

When aircraft are to travel from the ramp to a runway, they must negotiate through a series of taxiways to get to the assigned destination. The destination is assigned to the aircraft by the ground controller who specifies a route to be taken. The aircraft is moved away from the ramp by a ground tractor with a driver and an outside man who guides the tractor driver and who watches to see that the movement does not conflict with other aircraft movements. Frequently other aircraft are being moved to or from ramp positions at the same time and care must be observed to assure a safe movement. The outside ground man is in contact with the aircraft crew while the ground crew is moving the aircraft. This outside crew affords some degree of protection against collision between aircraft and vehicles in the area. Once the aircraft has been turned to the proper aspect for approaching the taxiway system, the ground crew leaves the aircraft and it is under the control of the flight crew.

The movement of the aircraft to and through the taxiways to the runway is under the direction of the ground controller. By radio, he directs the aircraft through a route and to the proper runway. This activity requires the complete attention of the ground controller who must also do the same function for other aircraft going to a runway and still others coming from a runway to the ramp. It is the responsibility of the controller and aircrews to be alert to conflicting movements of other aircraft and vehicles. More responsibility is placed on vehicles, since it can be difficult for aircrews to see the vehicles.

When the aircraft reaches the runway, it is told to either hold or proceed onto the runway and prepare for takeoff. This is a critical time because if the aircraft is instructed to hold clear of the runway due to an incoming flight and it over runs the edge of the runway, a collision can easily occur. The instruction to hold or proceed is totally through an understanding of voice communication between the ground controller and the flight crew.

Once the flight crew has received permission to occupy the runway, the aircraft is positioned for take off. The ground controller gives permission by voice for the aircraft to take off and they proceed on the roll. The situation here is dangerous because once the aircraft begins to accelerate, it is difficult to stop if a vehicle or other aircraft crosses or incurs upon the runway. The ground controller tries to control the conflicting movements, and ground vehicles must be extremely careful when crossing active runways. As a departing aircraft proceeds down the runway, a following aircraft may be given permission to occupy the end of the runway as preparation for takeoff. In addition, as a leaving aircraft proceeds down the runway, the ground controller may improperly give an aircraft or vehicle permission to cross the runway. He may also give permission for a following aircraft to begin takeoff. This can result in confusion on the part of flight crews and has been the cause of a number of near misses and actual collisions.

As an aircraft approaches an airport, the approach controller directs it to a particular runway for landing. Once the aircraft is on the ground, the ground controller takes over and directs the aircraft to a particular turnoff from the runway and a route to the ramp. As the aircraft is in the act of landing, the approach controller is in charge of the aircraft and the ground controller is in charge of movements of other aircraft and vehicles. This requires close coordination between the controllers to assure that no conflicting movements have been authorized.

The ground controller has the responsibility of directing aircraft through taxiways to the proper ramp for discharging the passengers. It is the same responsibility as going from the ramp to the runway and involves concentration on the part of the controller to avoid directing traffic so that a collision cannot occur. At some airports, a tractor and outside ground crew member pulls the aircraft to its final unloading position, while at other airports the positioning is done entirely with aircraft power with direction from the ground.

In addition to the aircraft traffic, the volume of vehicular traffic and the number of path intersections make the probability of collisions potentially high, and human error is a reality. Tow tractors, fuel trucks, baggage trains, crew busses, maintenance trucks, security cars, mail trucks, and emergency vehicles all tend to go rapidly to their individual destinations with their specific task as their primary focus. At some large airports, vehicle traffic around taxiways and runways is restricted to special roadways, but at most airports the vehicles use the same paths as the aircraft. This is dangerous because it is difficult for flight crews to see the vehicles due to the elevation of the aircraft cabin and the difficulty of bringing a large airplane to a quick stop to avoid a collision.

Known Systems

One system that has been devised to control airport ground traffic is described in U.S. Pat. No. 3,706,969 to Paredes. The Parades system describes the use of a digital computer, ground detectors and signals to guide the traffic. However, there is no disclosure or suggestion of a programmable logic controller or any specialized program utilizing progressive solution logic to insure the most efficient flow of traffic. There are also numerous additional patents and available systems that relate to various types of detectors or other features.

Other industries have conceptually related traffic issues. Conveying product in a factory, directing the flow of automobiles at intersections and routing of railway trains are all traffic direction problems. Vehicular traffic started being controlled by police officers at the intersections, which were replaced by timed traffic signals and eventually by vehicle volume controlled signals. Product conveyors at first were individual motors that had to be started in a specific order. The motors were started individually, relying on humans to operate the system properly. Electrically interlocked motors to assure proper sequential operation replaced this method. This has been replaced by computer controlled systems to assure proper product delivery. Railway routing started out as manually operated turnouts, which were replaced by mechanically operated and interlocked switches and signals. These have been superseded by electrically interlocked systems and finally to systems where the entrance point to and the exit point from a complex interlocking are selected and relay logic positions the turnouts for proper routing. These NX (eNtrance-eXit), UR (Union Route) systems use relay logic.

### BRIEF DESCRIPTION OF THE DRAWINGS

FIG. 1A is a schematic drawing of an airport plan with area designations. This figure shows a typical airport plan for a small airport and the designations of runways, taxiways and intersections.

FIG. 1B is a schematic drawing of an airport plan with signal positions. This figure shows a typical airport plan for a small airport and indicates where signals would be placed to govern ground movements on the runways, taxiways and through intersections.

FIG. 2 is a front view of the lights in a preferred embodiment of an airfield directional signal. This figure shows the arrangement of LED's that would be used to indicate the direction traffic is to take at intersections.

FIG. 3 is a schematic diagram demonstrating the possible signal indications that will be displayed on the signal shown in FIG. 2 and the circumstances that would cause the signal to display.

FIG. 4 is a schematic drawing of a runway-runway intersection. This drawing shows the arrangement of equipment, i.e., signals, detectors, equipment housing, at an intersection of two runways. It also shows the control video monitor display for the intersection.

FIGS. 5A-5F illustrate the working and development of progressive solution software.

### DETAILED DESCRIPTION OF PREFERRED EMBODIMENTS

This proposal is to provide a system of traffic signals at the intersections of traveled airport pathways, i.e. taxiways, runways, and vehicular roadways, to direct traffic to prevent simultaneous use of intersections. Preferably, a ground controller sets routes for traffic on a console in the control tower that grants the right to an aircraft or vehicle to travel a directed path. The system will prevent the controller from establishing conflicting paths and it will automatically provide the moving traffic with the shortest, clear route to move from a point to its destination on the ground.

The controller will have knowledge of all movement, taxiing, landing, take off, movement of vehicle, etc. via a preferred color video monitor screen upon which a diagram of all or part of the airport taxiway and runway system is shown. The class of vehicle, i.e. aircraft with airline and flight number, security vehicle type, etc. will also be shown. The vehicle class will be entered using a keyboard. The controller will then touch the video screen at the place that represents the point where the movement is to begin and the screen will present a display that will indicate that a movement request has been registered. The system will then display a number of destinations that are available to terminate the movement related to the class of vehicle and the controller will select the desired destination. The originating point is called an “entrance” where the traffic is to enter the controlled area, and the termination is called an “exit” where the traffic is to leave the controlled area.

With the route established, the traffic signals in the route will indicate the path to be taken and the video screen will indicate that a route has been established. Normally the taxiway and runway system paths on the video are white areas with the runways wider than the taxiways. The areas outside of the paved runways and taxiways will be green representative of grass. When a route has been established, the route pathway will change to blue. As the vehicle or aircraft proceeds through the route, the pathway changes to red when the section is occupied and the vehicle classification icon moves as the vehicle proceeds. The route path reverts to white when the path section is clear. If another If another movement is requested which does not conflict with the already established route, the second route can be established. If the second route does conflict with the original route, the system will seek to find an alternate route to allow the second movement. Alternatively, the controller can establish the second movement in a partial route up to the point of the conflict where the second movement will wait for the first movement to clear.

With the route established, the airport traffic will proceed to the established entrance point. A green or yellow arrow signal indicating to proceed into the controlled space will be displayed on the entering signal. As the airport traffic passes the signal, a sensor in the pathway detects its presence. This presence is indicated on the control screen and also causes the signal to display STOP so that succeeding airport traffic cannot follow without having an approved route established. If such a follow on movement is a regular procedure, special signals and actions are required as described later.

When a route is established, all conflicting routes are locked out. When the airport traffic accepts the route at the entrance signal, the lockout of conflicting routes in advance of the airport traffic is retained, even though the entrance signal has gone to a STOP indication. The entrance point is cancelled and released for another route selection. The video screen displays the identification of the airport traffic in the representation of the path the traffic is occupying. This occupancy prevents the controller from authorizing other traffic access to that section of path, thus preventing following accidents.

As the traffic moves through the route, it clears intersections and pathway sections. The lock out of these pathway sections and intersections is released as the traffic proceeds through the route. As the clear out occurs, other routes may be established that make use of the intersections and pathway sections. When the traffic reaches the end of the selected route, it faces a STOP signal, unless a further route has been established.

If an authorized movement is taking place, but the traffic deviates from the authorized route, this deviation will be shown on the main video screen and also as an alarm on the emergency alarm screen. The event will also be recorded on a printout that shows the nature of the deviation and the traffic classification. When such a deviation occurs, all traffic is still protected by stop signals so that other traffic is prevented from entering an occupied section of taxiway, roadway, or runway. The deviating traffic must then contact the ground controller by radio, identifying himself and his location and requesting an authorized route.

If the controller attempts to establish a conflicting route or an invalid route i.e. attempts to send an aircraft down a vehicle roadway, the system will refuse to accept the instruction. Normally, the system automatically selects the shortest, or most direct route between a selected entrance and exit. However, if for some reason this route is not available, the system automatically selects the next most desirable route. This alternate selection process continues until either a route is found or none can be found. If an entrance is requested and no valid exit can be found, the entrance selection will be cancelled within a set time of the entrance selection.

Once a route is established, it can be cancelled by touching another point on the screen near the entrance selection point. If no traffic is approaching the entrance signal, the route is cancelled immediately, all signals in the route go to STOP and locking of conflicts is released. If traffic is approaching the entrance point and the route is cancelled, the entrance signal goes to a STOP aspect, but the route will stay locked long enough for the traffic to observe the STOP signal and halt. If the traffic over runs the stop signal, the locking will be retained, but the next signal will have gone to a STOP display.

If traffic over runs a STOP signal, the system will automatically cause alarms to be displayed and the system will take actions to display signals to other traffic that may be affected by the over run. The system is aware of the identification of the intruder and it records the time, date, intruder identity, and location of the intrusion.

There are circumstances in an airport where it is required that aircraft or other traffic be lined up successively. These situations will be designed into the system to allow this at needed points. When aircraft are lined up waiting, or stacked, for an available runway, provisions can be made in the software to store the traffic identifications in order and allow them to follow closely. The controller sets up the first runway route and the aircraft proceeds onto the runway and takes off. As a departing aircraft clears the runway, the route for the next aircraft may be set after a two-minute delay to assure separation of departing aircraft. The same basic operation is used for landing in that an entrance is selected at the beginning of a runway and exit points will be shown as flashing yellow lights. One or more of these lights may be pressed to establish exits. The exit points of succeeding aircraft will change to assure that an unoccupied exit is available for each landing aircraft.

At roadway intersections, the signals will operate in a normal traffic signal manner by time interval or vehicle count methods. A special entrance button on the video will be placed at the represented point for emergency vehicles. Pressing this entrance button will cause all selected routes except take off and landing to be cancelled. The controller selects an exit point closest to the point of the emergency and route is established. The emergency vehicles will follow the direction signals to the selected point and the safety at intersections will be maintained. Security of access to the controlling equipment or software will be severe.

Signals

Typically, the present method of communicating the route to be traveled by an aircraft or vehicle is by radio instruction from the ground controller. The present invention prefers that light signals similar to vehicular traffic signals be placed at all intersections of taxiways, runways, and vehicular roads. The signal “lights” will be made of a number of light emitting diodes (LED's) which will emit red, yellow, or green light. The “roundel” will consist of a matrix of these devices so that certain aspects can be displayed. The signals will display a red horizontal bar for a “STOP” instruction. The red LED's need only be through the center area of the roundel. The signals can also display yellow or green arrows using the LED's to indicate the path to be followed by the observing vehicle or aircraft. An arrow pointing to the left indicates a left turn, an arrow to the right indicates a right turn and an arrow pointing straight up indicates a straight ahead path. If paths are at an angle to the approach path of the vehicle or aircraft, angled arrows are displayed to indicate the path to be taken. Since the signals apply both to vehicles where the observing driver is 5 to 8 feet above the path and to aircraft where the observer may be 30 feet above the path, the signals must have an optical system which has at least two focal points. The signals will be no taller than 24 inches from the ground and be equipped with breakaway bases. Some signals may require sun shields to protect the indication from being washed out by sunlight.

Control Console

The control console consists of one or more dedicated “touch screen” video displays on which the layout of taxiways, runways, and controlled vehicular paths are displayed. A flight identification number indicates aircraft, which will move as the aircraft proceeds through the directed path. The type of service the vehicle is engaged in, i.e. police, fire, baggage, etc will indicate vehicles. Icons will be used to identify the traffic and the icon will display the identification or traffic classification.

Malfunctions or alarms such as fire, unauthorized space incursion; etc. will be displayed on the video screens. The location will be displayed on a separate alarm screen representing the point of alarm on the airfield. The type of alarm will be an icon with describing words and the event will be recorded on a printer located in the control room. The operator touching the screen at the point where the display indicates the alarm will acknowledge alarms. This system will not replace existing fire and security alarms, but will be alerted by them so that the ground controller can better direct traffic as necessitated by an emergency. Ground control signals will be shown on the screens displaying the same aspect as the signals in the field.

Control Equipment

The control logic will be programmed into a programmable logic controller with remote input-output (I/O). There will be a central processor at or near the control console, which will coordinate all movements. There will also be a redundant central processor located in a building removed from the control tower. The redundant processor will monitor all operations and have the same operational software as the main processor. If the main processor fails, the redundant processor will take over operations without affecting traffic routing, either in progress or selected. The central processor will communicate to remote equipment vaults located at each intersection. These vaults will have I/O points for the output of signal displays and the input of traffic movement. All logic to control traffic flow will be in the central processor, which will also interact with the control console video displays. Information will pass to and from the field locations via fiber optic cable for maximum data transmission speed.

A programmable logic controller (PLC) is an electronic device capable of solving Boolean equations that a user programs into the device under the direction of a non-modifiable operating system. The user program can be written and entered without compiling and is processed in complete scans of the program rather than as a conventional interrupt driven computer program. The PLC has an inherent capability to control and monitor an input/output structure and does not require specific driver software for input/output hardware.

Progressive solution logic is a system for route selection that dynamically insures the selection of a clear route through one or more intersections defined by an airport pathway layout. Upon selection of an entrance point into the airport pathway layout, the progressive solution system solves a group of Boolean equations to determine a safe and clear path through the entrance point. This solution of the group of Boolean equations, i.e., the safe and clear path, is then passed to the next group of Boolean equations, which represent the next intersection in the finite group of exit points. The solution of each succeeding intersection group is passed to the possible end points in the route. When the end point of a group of possible endpoints is selected, the software progressively verifies the selection in the reverse order until the beginning Boolean equations at the selected entrance are verified.

Detection

The detection of the passage of traffic, whether it is aircraft or vehicle, will be by loop antenna detectors imbedded in the pavement. These will act similarly to the present vehicle detectors for highway traffic signals. The logic in the system will permit these detectors to acknowledge the passing of a vehicle or aircraft as well as its presence. This means that the detector loop does not have to be large enough to surround a large vehicle or aircraft and the same equipment can be used for any type of traffic. Of course, other types of detectors could be used including, but not limited to, detectors based on motion, visual recognition, global positioning systems, etc.

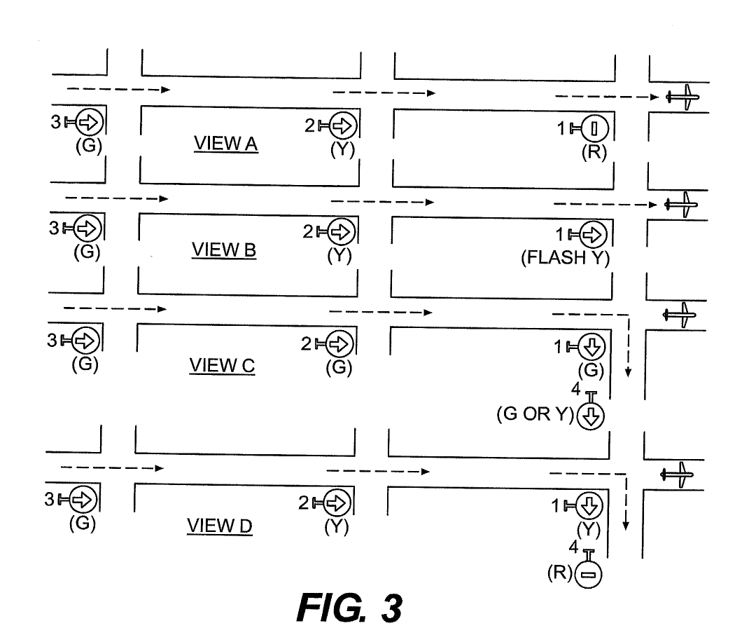

Signal Indications (FIG. 3)

View A shows the indications that are displayed on signals in a straight through route. Signal 1 displays a straight red bar giving a STOP indication because there is an aircraft occupying the space beyond the signal. The next signal back, Signal 2, displays STRAIGHT APPROACH, a yellow arrow pointing straight ahead. This indicates that the path is clear and set up for a straight through movement, but that the next signal displays a STOP indication. A pilot of an aircraft following the one shown would reduce speed to be able to stop at Signal 1. The last signal displays STRAIGHT PROCEED, a green arrow pointing straight ahead.

View B shows the same conditions as in View A as far as the first aircraft is concerned. However, at certain points in the taxiway system, there may be a requirement to gather aircraft close together while they wait for clearance to enter upon a runway. A section of taxiway where this is required has special software so that the controller may set up the stacking. When he does, Signal 1 displays, STRAIGHT AHEAD RESTRICTING, a yellow arrow straight ahead flashing. This instructs a following aircraft to proceed at a low speed to be able to stop short of another aircraft.

View C shows the signal displays when a route is set up for a diverting or turning movement. Assuming that Signal 4 displays an aspect other than STOP, Signal 1 displays RIGHT TURN, a green arrow pointing to the right. Since the travel speed of aircraft when taxiing is slow, a speed restricting aspect on Signal 2 is not necessary. If Signal 4 is displaying a STOP aspect, the indication on Signal 1 will be SLOW RIGHT TURN, yellow right turn arrow as in View D.

Other aspects could be used if necessary for special operations or circumstances.

Interface With Landing Lighting Systems

The present landing approach lighting systems will be retained. When the ground controller sets up a landing route, the approach lighting system for the selected runway will be activated.

Runway and Taxiway Lighting Systems

The present runway and taxiway border lighting systems will be retained. However, controls can be arranged so that the directed route border is illuminated.

### EXAMPLE

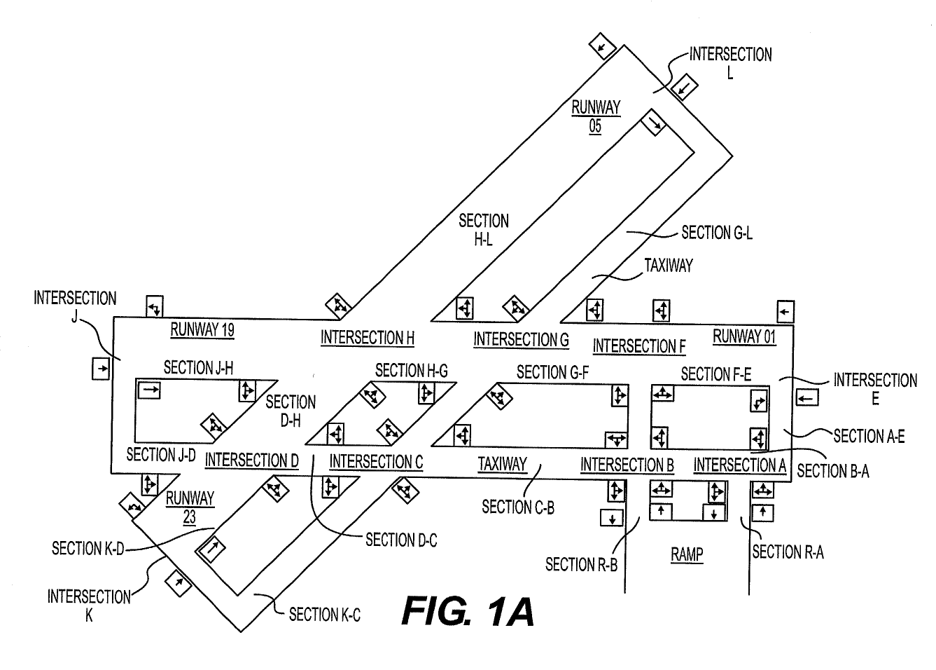

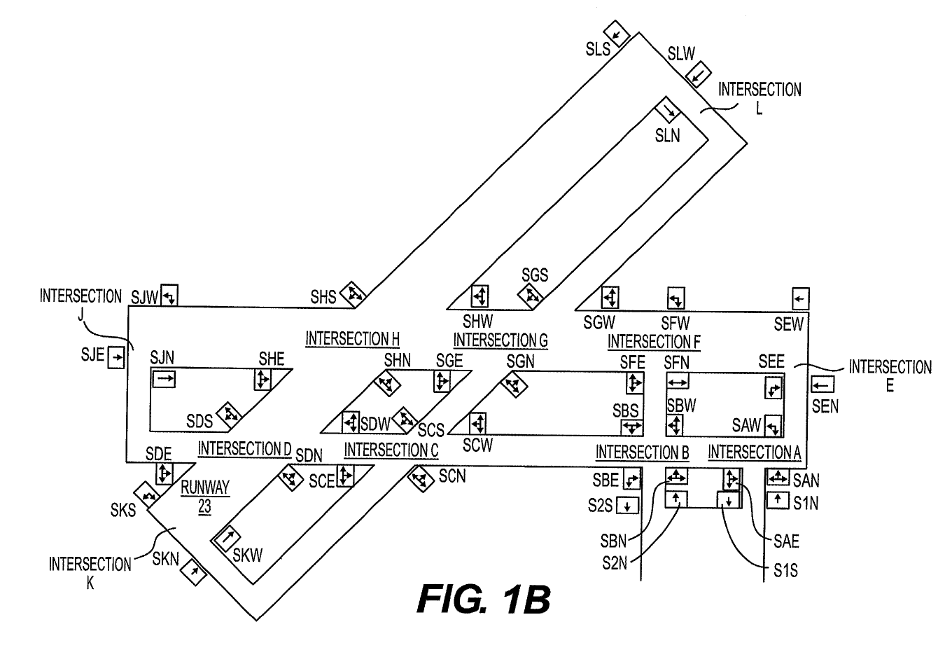

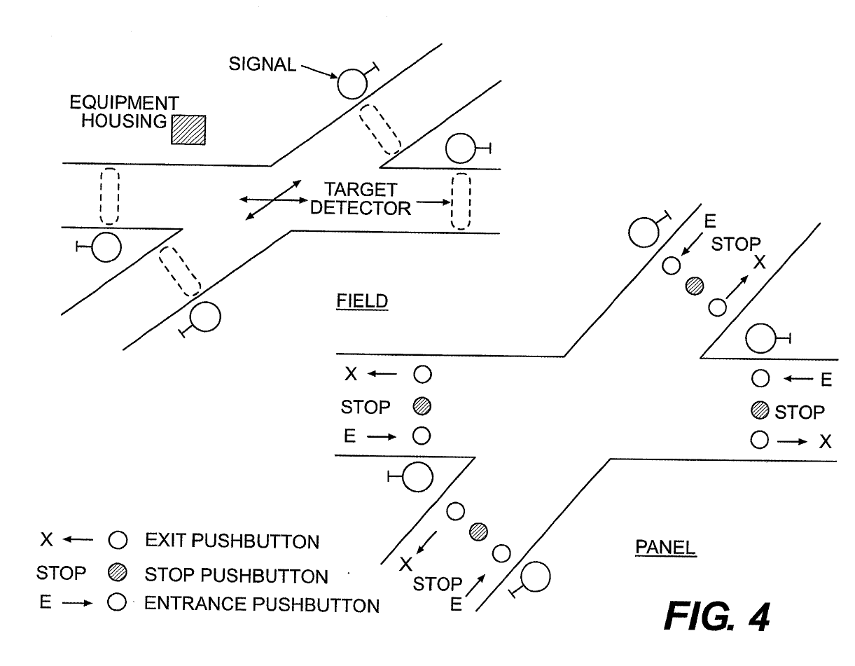

1. Layout Plans (FIGS. 1A and 1B, FIG. 4)

A scale plan of a hypothetical airport is generated that shows all of the runways, taxiways, and roadways whether they are to be included in the control system or not. In general, a terminal area will not be traffic controlled because in many cases, the travel pathways are not defined. The plan shows all of the facilities including service buildings, passenger buildings, and equipment housings. This layout is used as a basis for the detail layouts of each intersection. Each controlled intersection is assigned a unique designation that is used on all drawings pertaining to that intersection. (See FIG. 1B). All runways are identified with the number assigned to them for operations. Taxiways and roadways will be assigned unique numbers that will be shown on the plan. These identifications are shown on all drawings that show such pathways. The controller housing location and the location of each signal will be shown on the detail plans. The signals will be assigned numbers that are associated with the pathway they govern and the direction to which they pertain.

2. Wiring

Fiber optic cable is preferably used to connect and carry instructions from the control panel to the programmable logic controller to the field detectors and signals. The signals absorb very little power, since they employ LED's. The I/O itself consumes very little power, since it is mainly solid state gates. It is intended that the entire system will operate on 12 volts DC so that ordinary storage batteries may be used to maintain operations when power fails. Normally, the system will take power at any AC voltage, which is convenient to the location. This will power a transformer-rectifier assembly that will charge the standby batteries and provide normal power to the system. In this way if power fails at the source location and then is restored either through an emergency generator system or through normal power means, the control system will continue to operate without interruption. This is important because if a route is set up and an aircraft is passing through the route, a power interruption to the system inputs would cause the route to be cancelled.

The detection means for aircraft or vehicles will be like the buried loop antenna system currently used at controlled highway intersections. An electronic signal generator will be located in the control housing for each detection point in the intersection. The detector loops will be installed in the pavement and consist of ordinary copper wire.

3. Controller Housing

The input-output points will be housed in an underground vault near the intersection. This housing will also contain transformers, rectifiers, a storage battery, and electrical terminal boards for the termination of field wiring. The housing must be locked securely so that only authorized personnel will have access, but the lock and access door must be so designed that access can be gained under adverse weather conditions. Since these housings are part of the airport safety system, a command signal from the ground controller must be received at the housing in order for a local key to unlock it. In the event of complete power failure, it is preferred that two keys must be used to open a housing door. If the signal housing front lens or rear door is opened, an alarm will be displayed on the alarm screen so that security personnel can be alerted.

4. Controller Hierarchy

The general hierarchy of the programmable logic controller (PLC) system will be that there will be a master central processing unit (CPU) located in the control tower. This will be connected through a fiber optic cable to a standby CPU located remote to the tower. These will be connected through other fiber optic cables to remote I/O in the field.

5. Input Components

The principal inputs will be the traffic detectors. The detector electronic package will provide a discrete input to the PLC that will be energized when no traffic is being detected. This provides a fail-safe system. If the detector fails in any way, or traffic is being detected, the input to the PLC will be deenergized. If other discrete inputs are required, they shall be normally energized and fail deenergized.

6. Output Components

The principle outputs will be the signal lights. In order to keep the number of output points to a minimum, communication between the output cards and the signals will be a four wire binary coded decimal (BCD) system. This can provide up to sixteen different output signals, where only ten are required for the display. Normally the BCD code for a red, STOP, indication will be sent to the signal. When the aspect is to change, the PLC will energize all four wires to the affected signal. The signal will retain whatever display is showing, but will send a signal back to the PLC input that the signal has received the pulse on all four wires. This provides a test that the four wires are intact and when the PLC received this verification, it will energize the four wires in the BCD code for the new display. The signal electronics will decode this new information and place the new display on the LED's. This verification occurs at each aspect change, but the system failure display for every signal is STOP.

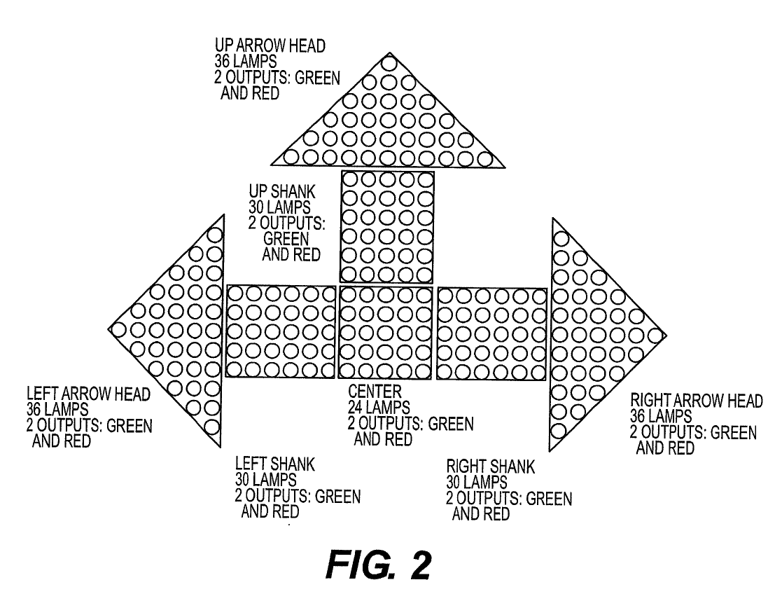

7. Signal Design (FIG. 2)

Each signal will consist of one projecting head with colored light emitting diodes (LED's) for display. The LED's will be mounted on circuit boards that will have connecting paths terminating on one edge with screw type terminals. The head will have four terminals for receiving the BCD display code and three, hot, neutral, and ground, terminals for power. The housing will be weather tight with a locked rear door access to the wiring terminals. Wires will enter the signal unit from underground. The signal will have a breakaway base and a wire plug so that if it is struck by aircraft or a vehicle, the signal itself will not b e damaged and the wires will not be broken. This condition will be shown as an alarm on the control console.

Of course, other types of signals could be used to communicate the same or similar types of directional information to the airport traffic.

8. Panel Screens (FIG. 4 [typical])

The control panel will be a touch screen CRT, typical for modern control. The CRT will normally display the airport layout of runways and taxiways in broad white paths, the runways being wider than the taxiways, with green “grass” in the other areas. It will also show the location of the ground signals under the control of the system. The signals on the screen will display the same indication that is shown on the ground signals. When a route is to be established, the center of the pathway or intersection is touched and a detail of the point replaces the general layout. The detail will show circles to represent entrance (E) and exit (X) buttons, which will display colors as appropriate when they are in use. When a complete route is established, the detail is replaced with the general layout, displaying the new signal aspects and the selected route.

Icons on the screen will be used to represent traffic. Aircraft will be represented by a fuselage symbol with perpendicular “wings”. There will be space in the fuselage to show the airline and flight number. A box with wheels will represent vehicles. The box will be colored to represent types of traffic, i.e. red for fire trucks, blue for police, etc.

Of course, other types of control panels and icons may be used. The specific equipment and icons may be customized for any purpose.

9. Alarm Screen

The alarm video screen will use words in various colors with different backgrounds to distinguish the severity of a particular alarm. The colors, wording and any icons employed will be developed with the assistance of local airport personnel so that the conditions for a particular airport may be incorporated.

It should also be noted that while the use of a touch screen and entry by a human controller is preferred, they are not required. A wholly automated system could be programmed, for instance, for a small airport with minimal traffic. Even larger airports that have a small or otherwise manageable flow of traffic could be handled with a system including only a programmable logic controller (having progressive solution logic software), detectors and signals.

10. Software

The PLC software will be installed and shown on displays and printouts in the standard manner for programmable logic controllers. The touch screen software will be done in accord with the state of the art. Normally access to the software in the PLC and the controlling touch screen is open. But since this system is part of the security arrangements for the airport, access to either the processors or the printouts must be rigidly controlled.

Operation

General (FIG. 1)

The general operating scheme in a preferred embodiment is that the ground and approach controllers in coordination with each other establish the point where an aircraft or vehicle enters the controlled area.

One or more color video monitors on which the layout of the runways and taxiways of the airport are shown as wide, white lines, the runways being wider than the taxiways. The location and the displays of the signals under control are shown in their proper respective locations. To establish a route, the operator touches the center of the intersection or pathway at the point, which represents the point where traffic will enter the control area. The general layout of that area is replaced by a detail, which displays buttons, which are dark except for the STOP buttons, which are steady red lights. The operator touches the circle represents the appropriate entrance point and the circle changes to a flashing blue light. The system then illuminates flashing yellow lights at available valid exit points.

The system is programmed to determine which exit points are valid. For example, a vehicle roadway exit point is not valid for an aircraft. If a route for a movement has been previously established, an exit point that requires a conflicting route will not flash and is not valid. The conditions of validity are established when the PLC (programmable logic controller) program is written.

The operator touches the screen at the center of one of the intersections with a flashing yellow light. The entrance point layout detail is replaced by the exit point detail. The operator then selects one of the flashing exit buttons and a route is established, which is the most direct for the intended movement. If the most direct route conflicts with a previously established route, or a section of pathway blocked for maintenance or construction, the system will establish an alternate route to the exit point. With the route selected, the entrance and exit buttons go to a steady on condition; the red STOP button and all unused exits go dark.

The pathways from entrance to exit change from white to blue to indicate the established path for the movement. The signals in the field that are in the route change from a red STOP indication, to an arrow PROCEED indication. Similarly, the signal representations on the video screen indicate the cleared signals. If there are flush route indicating lights in the pathway, these light up to indicate the path to be taken.

When the vehicle or aircraft passes the signal at the entrance point, the signal goes back to a red STOP indication, which is repeated on the video screen. Also, the section of pathway displayed on the video screen changes from blue to red, showing that the section is occupied. The entrance button on the video screen goes dark and the STOP button lights up red. As the vehicle or aircraft proceeds along the route, the signals change to STOP as they are passed. The video display follows the movement as it proceeds and the pathway sections go back to normal white lines, as they become unoccupied. The flush route indicating lights go dark as the vehicle or aircraft clears them. As a section or intersection is cleared, it is released from the interlocking so that it may be used for a subsequent route. The aircraft or vehicle reaches the end of the cleared route at a STOP signal or some other indication of completion of the movement.

The layout in FIGS. 1A and 1B illustrate the detailed operation of an exemplary system with respect to aircraft and vehicle operations. This is a layout of a portion of a hypothetical airport (FIG. 1A) and also of the video control screen (FIG. 1B). Runway 19 goes east and runway 01 goes west. Runway 23 is northbound and runway 05 is southbound. The signals are designated in accord with the intersections they protect and the direction to which they apply. The intersections are designated “A” through “L”

The signals are used for two purposes. First they are used to direct the approaching aircraft or vehicle to show the path they are to take. Second, they are used to indicate conditions ahead and infer the speed that the movement should use. Exemplary signals were discussed earlier herein in connection with FIG. 3.

The drawings show signals stationed only at intersections. There may be instances, particularly on taxiways where stacking is required and intermediate signals may be placed. These signals could be controlled in the same manner as the intersection signals, or they could be completely automatic in operation, based on conditions of the path over which they govern.

When an aircraft is to depart from the loading gate to go to a runway for take off, the ground controller touches the control screen at one of the taxiway entrance points. The point touched on the screen will begin to flash as a blue light. All of the available exit points will also begin to flash as yellow lights. If runway 19 is to be used, the operator touches the point on the screen for runway 19 exit. The point turns on steady, as does the entrance point. All of the unused valid exit point displays go dark and the outline of the path on the screen changes from white to green.

In order to understand what occurs on the field, an example of such a movement will be detailed using FIG. 1 with an aircraft movement from the ramp through Intersection A to runway 19. The ground controller presses the Entrance Push Button (EPB) on the video screen at the representation of Intersection A. The button representation shows a blue flashing aspect. If no other route is established, all of the Exit Push Buttons (XPB) also begin to flash a yellow aspect. This includes all of the exit buttons at all of the intersections as well as the exit buttons at the runway entrances. This does not include the exit buttons from the runways. These are only operable for a takeoff. The controller then pushes the flashing exit button at runway 19. This button turns steady on, the entrance button turns steady on, and all of the unused exit lights, including the intermediate intersection exit lights, and the STOP button go dark. The path from Intersection A, through intersections B, C, and D turn from white to blue. Signal S1 changes from red to a green arrow pointing up, indicating a movement straight ahead. Signal SBN (Signal intersection B, Northbound) changes from red to an aspect of a green left turn arrow, and signal SCW changes from red to green straight ahead arrow. Signal S19N remains at red, as do all other signals. Signal SDW changes from red to straight ahead yellow arrow. This indicates that the route is clear, but that there is a stop signal ahead. The pilot of the approaching aircraft can control the speed of his aircraft to stop short of signal S19N. The signal symbols on the video screen mimic the signal indications in the field.

The aircraft moves from the loading gate to Intersection A. As it passes signal S1, the detector in the pavement senses it and causes the signal to revert to stop, button EPB 1 to go dark, the STOP button to red and the section of taxiway between signals S1 and SBN on the video screen changes to red.

When the aircraft passes signal SBN, its presence is sensed by the detector in the pavement, which causes the signal to go back- to stop and the intersection display on the video screen to go to red. When the detector at Signal SBN no longer senses the aircraft, the section of taxiway between Entrance 1 and Signal SBN reverts back to white. If the aircraft makes a left turn as directed by the aspect of signal SBN, the sensor in the pavement at signal SBE detects its presence. The section of taxiway between signals SBE and SCW turns red on the video screen and when the aircraft is no longer being detected at signal SBE, the intersection reverts to white.

If the aircraft had gone in any other direction but to the left at intersection B, the established route would have been cancelled and all signals would have gone to a STOP indication. The section of taxiway into which the aircraft had intruded would go to a flashing red and an audible alarm would sound. In addition, a display would appear on the emergency screen and a record would be noted on the event recorder.

As the aircraft proceeds along its proper route, the signals turn to STOP in turn as the aircraft passes each one. All of the sections of taxiway on the video screen revert to white lines except the section immediately in advance of signal S19N, which remains red.

If the aircraft is held at the runway for some operating reason and a second aircraft is to be routed to the same point, another route to the same point may be established and all signals will clear as before. However, signal SCW will display a straight yellow arrow and signal SDW will display a flashing yellow straight arrow. This indicates to the approaching second aircraft pilot that he is entering an occupied section of taxiway and he must be aware of preceding aircraft.

If no landing operations have been set up on any of the runways and no movements established that cross runway 19, the ground controller presses the entrance button on the video at signal S19N and the exit button at signal S01E. Signal S19N displays a green right turn arrow, and signals SHE, SGE, SFE and SEE change from red to green straight arrow. The aircraft proceeds onto the runway, turns right and proceeds on the roll. As it passes signals on the runway, they revert back to red and as the intersections are cleared, they are available for another route. When detectors in the runway no longer sense the aircraft, the remaining portion of the runway route is canceled and all signals display red.

A landing is set up in much the same manner as a take off. In order to set up a landing, the entire length of the runway must be clear of vehicles or aircraft and there may not be any conflicting routes in progress or established. As an aircraft approaches the airport, the approach controller takes over directing the aircraft course. He informs the ground controller of the flight number and approach direction. The ground controller enters the flight data on his keyboard and then makes a runway entrance selection. The system checks that the runway is clear of aircraft and that no crossing or conflicting route has been established. The ground controller selects one or more runway exit points. Crossing taxiways, roadways, and runways are locked out from providing clear paths for traffic. All signals from the entering end of the runway to the nearest selected exit change the indication to green straight ahead arrow. The signals at selected exit points from the runway change to right or left turn arrow, depending upon the direction the aircraft is to follow. All conflicting paths are locked out when the signals change to a clear indication and the runway approach lights and edge lights are turned on.

When the aircraft touches down, the first point where it is sensed tells the system where the aircraft is and changes signals accordingly. If the aircraft does not touch down at the detector at the beginning of the runway, the signals from the end of the runway to the touchdown point go back to red as soon as the aircraft passes a detection point. Signals at turnoff points display green arrows pointing straight ahead up to the assigned turnoff point. The signal at that point displays a green arrow. Software can be set up so that the landing aircraft can turn off at one of a number of assigned taxiways. If the aircraft accepts one of them, the balance of the route is cancelled and the controller establishes a route to the terminal. If a taxiway section is occupied, the signal at that point only indicates straight ahead and the pathway cannot be used for an early turnoff.

If a movement had been set up on runway 23 or 05 in the taxiing situation described above, the ground controller could have set up the route from ENTRANCE 1 to signal SDW and the taxiing aircraft would hold there.

FIG. 4, shows the equipment that would be used at a typical intersection of two runways in the field including how the intersection is presented on the video control panel. Signals are placed on the right hand side of the runway to which they pertain and a detector loop is set at a point where if an airplane is detected, it will still be clear of the cross runway. The signals are set far enough back so that the pilot may observe the signal indication. The stopped aircraft is clear of the cross runway. The control equipment housing is located somewhere near where the edges of the runways intersect and underground cables are run to the signals and the detector loops. The signals are designated in the layout for the direction in which they authorize movement. For instance, signal N is for North bound movement. The signals can display all of the aspects shown in FIG. 3 so that movements through the intersection can be straight ahead, right turn, or left turn.

Passing through the intersection can be a short route. If an aircraft is to pass through the intersection north bound, the E button adjacent to the N signal symbol is pressed. This button begins to flash as a blue light and the X buttons at the other signals that are NOT adjacent to the signal symbols flash as yellow lights. If the movement is to be straight through, the controller presses the X button at signal S, but on the other side of the runway symbol. This button lights up as a steady yellow light, the unused X buttons go out, the E button at signal N changes to a steady blue light, and the STOP button at signal N goes dark. The runway outlines of the intersection and the space beyond signal S change from white to blue, signal N in the field changes from a red bar to a green or yellow arrow straight ahead, and the panel signal duplicates the field indication. As noted in FIG. 3, the indication on signal N depends on the display on the next signal, and the occupancy of the space beyond signal S. If the next northbound signal is red, signal N will display a yellow straight ahead arrow. If the next northbound signal is clear, signal N will display a green arrow.

The function of the E buttons is to act as an entrance request through a given space. The X buttons act as an exit from the space and define how far the route is to be authorized. If a route is to be set up that stops at signal N, the X button at the previous intersection would act as an exit for that route and it would flash yellow until it is pressed when it would change to steady yellow. If a longer route is to be authorized for a take off or landing, the route limits would be defined by an entrance south of signal N and an exit north of signal S. When these limits are established, the route section between signals N and S is automatically made part of the longer route and the ENTRANCE and EXIT buttons at this intersection are not used. However, when this longer route is used, the signal, runway and taxiway displays remain as described. The X buttons would flash yellow when the route entrance is selected, but will go dark when the more distant exit is selected. A blue entrance light and a yellow exit light, then define the route limits.

Regardless of the route limits, when the aircraft passes signal N, it changes to red, as does the runway space. If the entrance was selected at signal N, the E light goes dark and the STOP button goes to red, but the exit light stays on. The aircraft movement into the intersection space is detected by the loop at signal N. The PLC software is designed so that the aircraft checks itself into the space. When the front of the aircraft enters the field of the detector loop at signal S, the software conditions itself to check the aircraft out of the space. However, as long as the loop “sees” the aircraft, the software will not check it out of the intersection. The same loop checks the aircraft into the space beyond signal S and the runway lines in that space change to red to indicate occupancy. When the aircraft is clear of the intersection and the loop at signal S no longer “sees” it, the runway space on the panel revert to white and the X button at signal S goes dark.

Before an entrance selection is made, the ground controller uses a keyboard to enter an identification of airline and flight number or type of vehicle involved in the movement. The next entrance button selected will cause an icon with the identification in it to be displayed at the selected entrance point on the screen.

When an entrance selection is made, the system searches for valid exits from that entrance. If a valid exit is not selected within a set time after the entrance selection, the entrance selection is cancelled, as is the traffic identification. This is to prevent an entrance selection being made that stays indefinitely and that ties up a portion of the airport. It also minimizes the possibility of a route being established that is not intended when an exit is selected at a later time.

If an entrance is selected and there is an error in that the entrance was unintentionally selected, pressing the STOP button adjacent to the selected E button will cancel the entrance selection immediately. If a route is established and the ground controller wishes to change the exit point or cancel the route, pushing the STOP button will put the cleared signal to stop immediately. If there is no aircraft approaching the signal, the route is cancelled immediately and another route can be established. However, if there is an aircraft approaching the cleared signal and the route is cancelled, the signal will go to stop, but the route will remain locked until a time has elapsed. This time permits the pilot to observe and obey the stop signal and bring his aircraft to a halt. If this action is not taken, or the aircraft cannot be brought to a stop before passing the signal, the aircraft is still protected from cross traffic because of the route time lockout. If the traffic overruns the stop signal, the aircraft simply proceeds into the previously cleared space and stops at the next signal awaiting instructions.

When an aircraft or vehicle passes a STOP signal, the STOP button at that signal representation on the panel flashes red. An audible alarm will also sound so that the ground controller is aware of the occurrence. The light will continue to flash and the alarm to sound until the ground controller presses the flashing light. The runway or taxiway space occupied by the intruding aircraft or vehicle is shown in red and will stay that way after the controller acknowledges the alarm. Pressing the red flashing button will silence the audible alarm and the button will go back to steady red. There is an event recorder in the control area that will record the time, date, and nature of an intrusion. This record will also be stored in the PLC software from where it can be recalled at any time to the emergency screen.

The runway-taxiway layout in FIG. 1B operates similarly to the previous description with a notable exception. When a landing is set up as a route, several taxiway exits can be set at the same time. In this way the pilot can select the first available taxiway. When this is done, the signals on the runway indicate a turn in whichever direction is selected by the ground controller. If the pilot passes an available taxiway exit without accepting it, the signal changes back to red and the exit is cancelled. As soon as the pilot accepts an authorized exit point, all unused exits are cancelled and the ground controller then sets up a final route for the aircraft to the terminal. Taxiway exits for landing aircraft can be selected as long as there is no waiting aircraft occupying the space nor a route established which uses that space. If the aircraft does not accept any of the selected exit points, but instead rolls to the end of the runway, it is necessary to set up a route from the end of the runway to the terminal. Turning off of the runway to an unauthorized taxiway will be alarmed and recorded as an intrusion.

Initiating a route on to the runway from an end of runway intersection is for take off. Special software can be provided for any intersection to be used for a take off initiation. This permits aircraft with a short take off run to start in the center of the runway while a larger aircraft is at the end of the runway. For normal, large craft to take off, the ground controller presses the E button adjacent to the signal symbol. He also presses the X button at the other end of the runway diagram. The signal at the intersection displays a green right turn arrow and all of the signals along the runway indicate a green straight ahead arrow. All routes conflicting with the take off route are locked out. If a cross route had been in use when the entrance was selected, the X button at the other end of the runway would not have flashed and would not accept a command.

If the route selections are valid, the aircraft enters on the runway and turns right to begin the roll. As it passes the first signal, it goes back to red, denying a waiting aircraft permission to enter upon the runway. As the aircraft rolls down the runway, the signals it passes revert to red and as it clears intersections, the cross route locking is released. When the departing aircraft fails to be detected by a detector loop in the runway for a set amount of time, the system “knows” that the aircraft has left the ground. The remainder of the route is cancelled and another take off from the same entrance can be set up. If it is necessary for a pilot to abort a take off, he turns into any unoccupied taxiway and comes to a stop at the next signal. The ground controller then sets up a route for the aircraft to wherever is appropriate. Such a move cancels the take off route as soon as the aircraft turns off of the runway.

Landings are preferably always set up from the end of a runway, regardless of the size of the aircraft or its landing requirements. The E button at the entering end of a runway is pressed and it flashes blue. All of the available exits from the entrance point to the end of the runway flash yellow. The ground controller presses the X light at the taxiway at the other end of the runway. The X light goes to steady yellow and the entrance goes to steady blue. The ground controller may then select one or more additional taxiway exit points along the runway. An output from the PLC turns on the landing sequence lights and all signals from the entrance point to the first selected exit point show a green straight ahead arrow. The signals at the selected exit points change to a green right or left turn arrow. When the aircraft touches down and passes the first detector point, any route selection and locking behind the aircraft returns to normal, but the route locking and signal indications in front of the aircraft remain. As the aircraft continues down the runway, the signals change to red as it passes detector sections. When it turns into one of the selected exit taxiways, any unused exits beyond are cancelled and the signals and locking return to normal. When the taxiway exits are selected and a landing route confirmed, the ground controller might also select a route from the taxiway to the terminal. In this way, the aircraft is not delayed in its taxi to the terminal.

The control of vehicular traffic at an airport is not unlike the control of aircraft traffic with a few modifications. Vehicular traffic generally proceeds at higher speeds than taxiing aircraft and have shorter stopping distances. They are also more numerous than aircraft in some instances. Vehicles normally stay near terminals, but occasionally must venture out onto the aircraft operating area. At intersections of this type the vehicles are more concerned with approaching aircraft than they are for other vehicles. Routes may be set up for the vehicles exactly as they are for aircraft and the routes and signals will behave the same as they do for an aircraft. The detector loops will sense any vehicle and the system behaves as previously described. However, when a path that only allows vehicles intersects a taxiway or a runway, there are other considerations.

When an aircraft route is set up through the intersection, a vehicle roadway exit is not valid and the selection will be denied by the system. Normal operations are for the intersection to be on automatic control, which is established by pressing the AUTO button on the panel. This is a colored light, which will be on steady. The vehicle signals go to green straight ahead arrows and the aircraft signals remain at a red display. When an aircraft route is set up that passes through the intersection, the vehicle signals go to yellow straight ahead arrows for three seconds, or whatever clearance interval is appropriate, and then go red. The aircraft signal stays red until the vehicle signals have turned red and then the aircraft signal displays green straight ahead arrow. As the aircraft passes its signal, the display turns red, but the vehicle signals also stay red until the aircraft has vacated the intersection, when they revert to green straight ahead arrows.

If a vehicle movement is to be made using the aircraft paths, one of the vehicle E buttons leading into the intersection is pressed. If no aircraft movement has been set up, the vehicle signals go to yellow and then to red after the clearance interval. The X buttons leading out of the intersection flash yellow until one is selected. When it is, the E and X buttons go on steady and the unused exit goes dark. The signal leading into the intersection at the selected entrance will display right or left green arrow, depending upon the exit selected. When the vehicle enters the intersection, the entering signal goes back to red and when the vehicle exits the intersection, the selected entrance and exit buttons go dark. After the vehicle has cleared the intersection, automatic operation may be restored using the AUTO button.

At large airports there are pathways that are designated for ground vehicles only. Generally, these intersections are not controlled by any traffic device because the drivers can see approaching vehicles on an intersecting path. However, observations conclude that these are really very dangerous places because no authority is given to any vehicle to proceed with the exception of standing rules. Since the PLC has the ability to control a vehicle traffic intersection, it is proposed that signals be installed at these points. In this instance, the signal unit is modified to provide a solid yellow and solid green in addition to yellow and green turn arrows for operation described below.

Under normal operations, the signals at a ground vehicle only intersection preferably operate in AUTOMATIC mode by pressing the AUTQ button in the center of the intersection diagram. In this mode, the signals act exactly in the manner of road traffic signals with left turn phases available on demand. The signals can be arranged to operate in a strict time interval sequence with left turn phases at selected points in the time program or the software can be designed for a vehicle count or vehicle density system, since there will be sensors for this purpose in the pavement.

When conditions warrant, such as emergencies, the automatic operation of the signals is suspended by pressing any of the STOP buttons at the intersection diagram. Any signals that are displaying a proceed indication will immediately go to a yellow aspect for the clearance interval set time. After that period, all signals display STOP (red). The ground controller then selects an entrance and exit in the usual manner and the selected signal clears, showing the appropriate aspect of green straight ahead arrow or green right or left turn arrow. When a vehicle passes the cleared signal, it goes to a STOP aspect and the ground controller can then either select another route or can restore automatic operation. If the route is set up for emergency vehicles and more than one is responding, the signal remains clear until the ground controller presses the STOP button at the selected entrance.

When maintenance or construction is to be performed on any section of runway, taxiway or roadway that is under signal authorized ground control, the maintenance foreman proceeds to a signal governing movements over that section. He inserts a key into a slot provided, which requests that the ground control block movements through this particular section. An illuminated button in the center of the panel for that section flashes. The ground controller presses the flashing button, which changes to a steady light and no routes can be established through that section. When maintenance has been completed, the foreman again inserts a key in the signal head, requesting that the pathway block be cleared. The illuminated button in the pathway is extinguished and the path may again be used for traffic. If equipment is to be left on the pathway, the foreman does not release the pathway until all equipment has been cleared.

Emergency Services

If an emergency occurs on the airport field, the ground controller presses the EMERGENCY button on the video screen twice. Requiring that the button be pushed twice insures against accidental operation. When this action is taken, all signals go to stop except those on a runway where an airplane is taking off and any runway cleared for landing. If the cleared landing can be aborted, the ground controller presses the stop button at the entrance to the runway twice. When the EMERGENCY button has been pressed twice and a time has lapsed to allow moving aircraft and vehicles to come to a stop, exits, which are available from the emergency vehicle, garage flash. The ground controller selects the exit nearest the emergency site. Signals clear from the vehicle garage to the site and the route stays selected with the signals cleared until the ground controller presses the STOP button at the vehicle garage entrance point cancels it. When vehicles are to return to the garage, the nearest entrance is selected and the garage exit is also selected. This sets up a route for the vehicles to return to the garage.

Programmable Logic

Controller Hierarchy

The primary programmable logic controller (PLC) central processing unit (CPU) is located in the main control tower building. The PLC processor is installed in a rack that also holds the local power supply, the standby processor card, the fiber optic transmitter card and any local I/O cards for discrete functions. An auxiliary or secondary processor will be located in a very secure building separate from the control tower. Both processors receive all data and commands so that in the event of failure of the primary processor, change over to the secondary processor will occur without a change in operations. The entire network of equipment is connected by fiber optic cable to provide faster data transmission and a longer loop than can be typically provided with coaxial cable.

A programmable logic controller is used for this system rather than a computer for several reasons. A computer generally has a “storage” device such as a hard drive, disk, diskette, or tape, which acts as a “library”. These devices provide an enormous storage capacity, which is essential in some applications. However, the PLC does not have separate storage devices, which are subject to failure, and as a consequence, the PLC does not have the memory capacity of a computer. Furthermore, when power is turned on to a computer, it must go through a “boot up” sequence, whereas the PLC inherently has a dynamic executive program that does not require a booting sequence. For this reason, using a PLC provides instant on. Since this system includes security protection for the airport, access to the software in the processors will be limited by special arrangements detailed in the software section of this document.

The large CPU of any of the major manufacturers is capable of handling the software for the proposed system. However, the Modicon Quantum processor is the most flexible to use for the complicated software networks that are required. Furthermore, the Modicon processors can change over from main to standby in a “bumpless” transfer. The remote locations contain a rack to house input and output (I/O) cards to connect to the real world. The rack also houses a power supply for the cards, a receiver for the fiber optic cable, and an additional CPU if the design requires it. It is possible that the tower CPU will be used for network commands and those local processors will be used for local operations. Design can be done either way.

Programming of a Modicon Quantum processor is done in common ladder format as are the majority of programmable logic controllers. However, the system itself is flexible enough to permit programming in any common computer language. A printout of the PLC program will be kept in a secure place along with a disk of the program. Access to the program in the processor will be gained through the use of passwords and other security measures. If programming changes are being made, they are made only in the primary processor. While this is being done, control of the system will be through the secondary processor. When the changes are complete, the primary processor resumes control and the changes are automatically carried to the secondary processor.

The recorder will actually be a printer that will print events such as intrusion alarms; equipment failures, aircraft or vehicles passing stop signals unauthorized, emergencies, etc. Events will show the date, time of occurrence, nature of occurrence, aircraft or vehicle identification, corrective action taken, etc.

The control console for the entire system will preferably be programmed into a touch screen video system. The software for the video system will readily accommodate interconnection to the Modicon PLC. The software will be arranged with secure features so that operational access can only be gained by, for instance, the use of a password and a fingerprint identifier pad. Each authorized controller whose fingerprint is recognized by the identifier system will choose two passwords. One will allow him access to control the system and the second will be given to any unauthorized agent. This password will cause all signals in the system to go to STOP and notify airport security of an attempt to take over control. In order to restore operations, it will be necessary to gain access to a disk containing the video program, which will be stored in the security office and itself protected by a security system.

Programming Software for a Small Airport

Programming of a programmable logic controller (PLC) is usually done in the ladder format of relay circuits using the JIC (Joint Industry Council) symbols. These symbols are in general use in the United States and are understood by electrical technicians in many parts of the world. The PLC can do all of the switching functions of relay logic, but also can perform arithmetic functions and other functions to provide a flexible system.

The purpose of the system is to safely move airport traffic from one point to another. There are a number of ways this can be done, but this invention uses a “progressive solution” method. In this method, the system operator selects the point where the traffic is to enter the controlled area by pressing a “button” on the video monitor. With this point identified, the software searches for possible exits from the controlled area. It does this by interrogating each intersection that is on the way towards a possible exit. This interrogation is passed from intersection to intersection until it reaches all of the possible exits that can be reached from the selected entrance. The interrogation stops there and waits for the control operator to select one of the available exits. Once the exit is established, the system starts a reverse search looking for the entrance point. This search also proceeds from intersection to intersection, verifying the route to be taken. As the reverse search verifies a route at a given intersection (straight through the intersection, right turn, left turn), it cancels the forward interrogation paths that are not used. When the reverse search is complete and it locates the original entrance request, actions are taken to permit a movement over the path found.

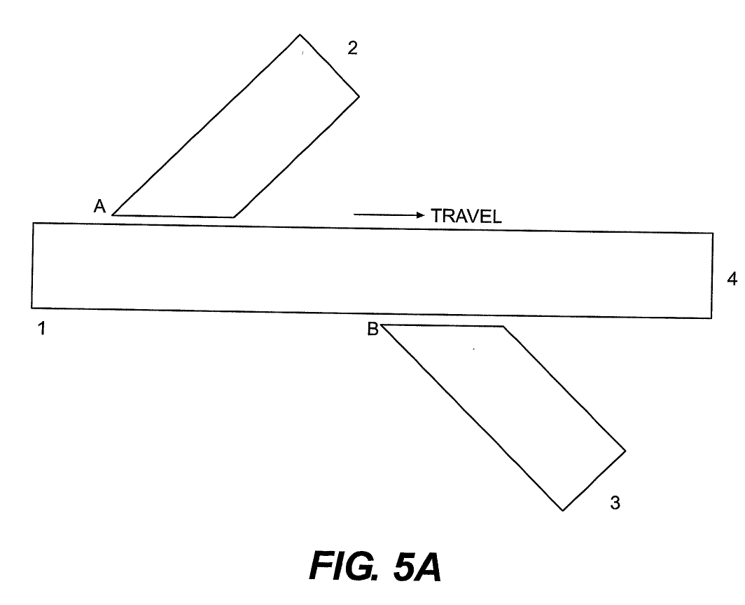

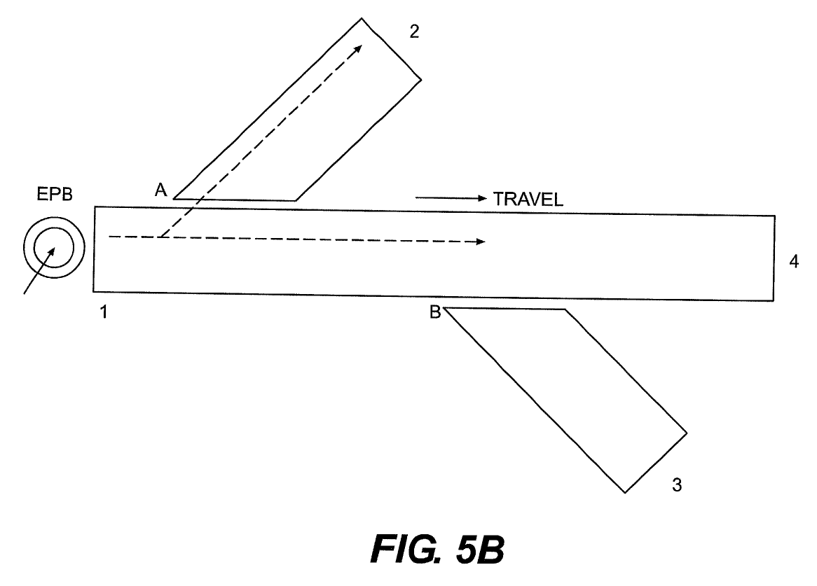

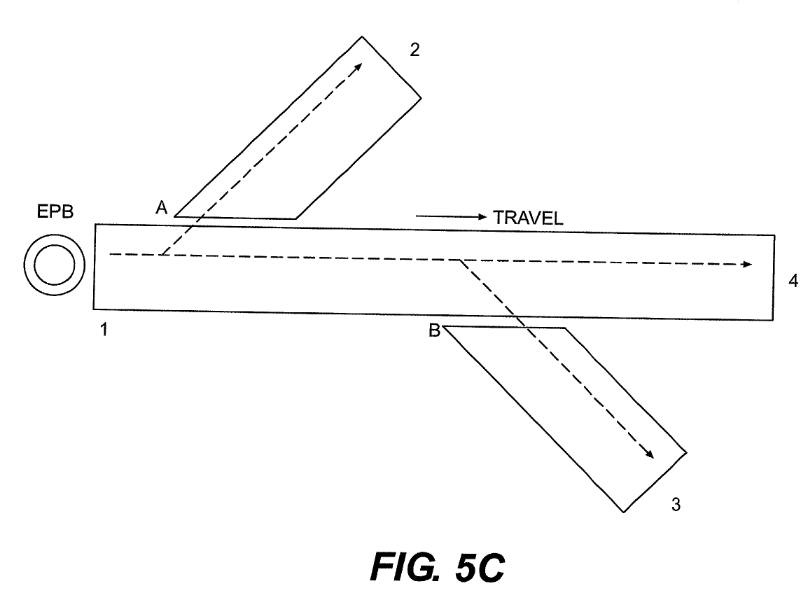

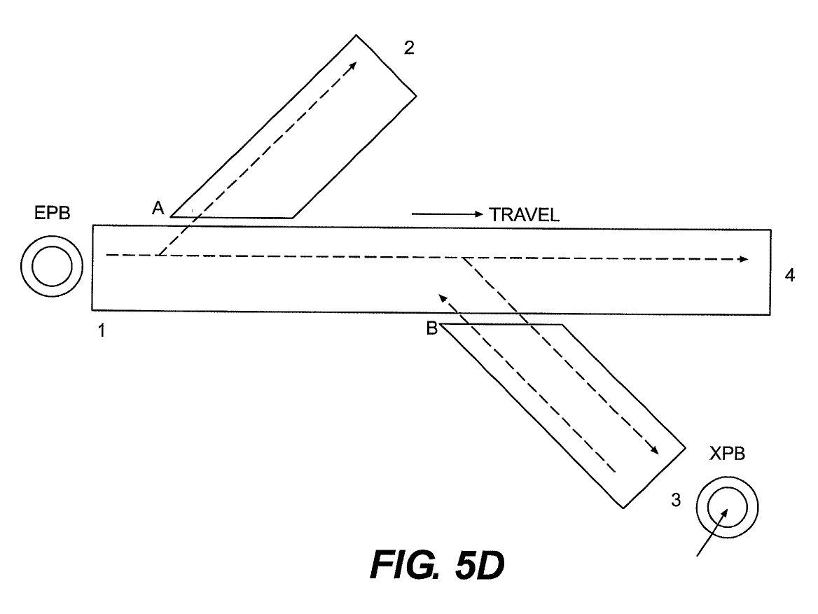

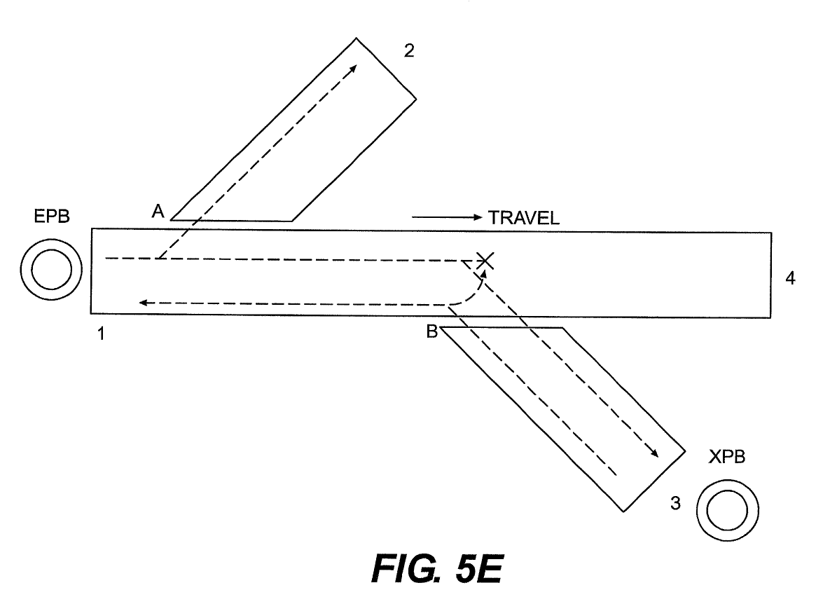

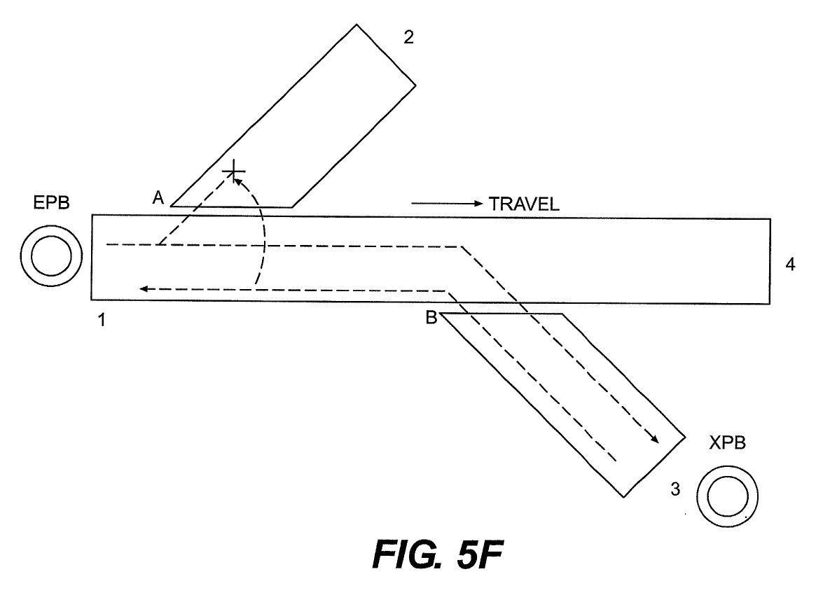

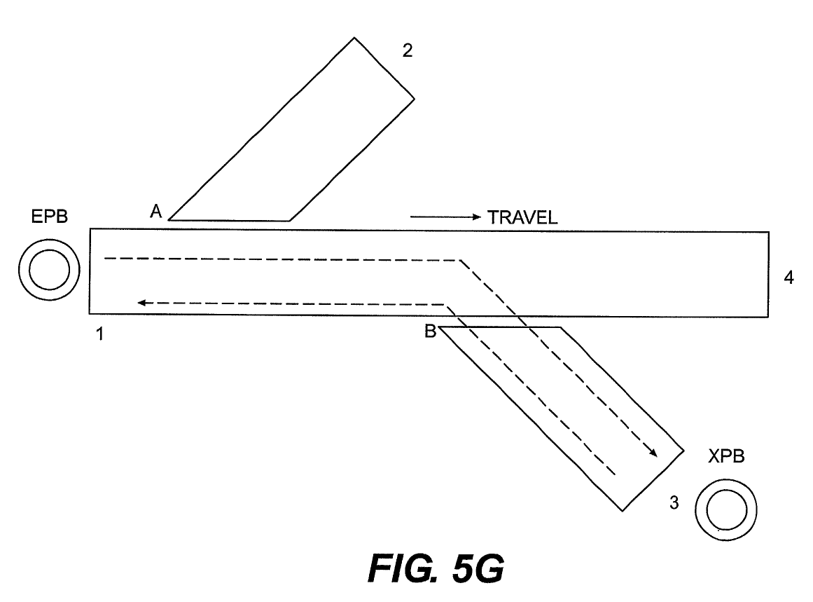

A look at a simple conveying layout in FIGS. 5A through 5G will show the interaction of the parts of the software. Conveyor traffic is routed from point 1 to points 2, 3, or 4 via junctions A and B. When objects are to move along the conveyor, an entrance push button (EPB) is pressed on a panel that controls the movements. This initiates a search forward to intersection A as shown in FIG. 5B. Since the system does not “know” at this point whether the switching device at intersection A is to send the traffic straight through to intersection B or to the left to exit 2, the system passes the entrance request forward down both paths. The request ends at exit 2 and proceeds to intersection B. Again, as shown in FIG. 5C, here the request is forwarded straight through to exit 4 and to the right to exit 3. The entrance request ends at these points. In order for the system to “know” how to route traffic, an exit must be selected, and for this example, an exit button (XPB) is selected at exit 3 as shown in FIG. 5D. This starts the verification to select the route desired. The verification is sent back from exit 3 to intersection B. At this point the right entrance and exit are on and the straight entrance request is cancelled as in FIG. 5E. The conveyor diverting device at intersection B is positioned to divert traffic to the right. The verification continues back to intersection A, as in FIG. 5F where the entrance request to exit 2 is cancelled. The straight through entrance and exit at intersection A positions the conveyor diverter device to route traffic straight through. The verification is passed back to the original entrance point, as in FIG. 5G and the route selection is complete. The combination of the entrance request and the exit verification at point 1 allows the conveyor motor to start.

What has just been described is the basic functioning of the system. However, in addition to this basic function, the software must prevent simultaneous conflicting routes, detect the movement of the traffic and its location, provide a means of directing the traffic, and also provide a number of safety features that must be incorporated.

While the invention has been described with reference to specific embodiments thereof, it will be understood that numerous variations, modifications and additional embodiments are possible, and accordingly, all such variations, modifications, and embodiments are to be regarded as being within the spirit and scope of the invention.

What is claimed is:

1. An airport ground control system for controlling the movement of vehicles over a network of pathways and intersections, the system comprising:
detectors placed at predetermined locations along the pathways and at the intersections, the detectors adapted to sense the presence or absence of vehicles near the detectors,
a programmable logic controller connected to each of the detectors, and
directional signals connected to the programmable logic controller,
wherein the programmable logic controller directs the route of vehicles based on input from the detectors, output to the directional signals, and further wherein the route selection is determined by progressive solution logic.

2. An airport ground control system as described in claim 1, further comprising a control panel connected to the programmable logic controller wherein the control panel comprises a display that shows the movement of vehicles over the airport pathways and intersections.

3. An airport ground control system as described in claim 1, wherein the route selection is adapted to be manually overrideable.

4. An airport ground control system as described in claim 1, further comprising a control panel connected to the programmable logic controller, wherein the control panel inputs vehicle entrance and exit information to the programmable logic controller that define the beginning and end of the vehicle route.

5. An airport ground control system as described in claim 1, wherein the directional signals are adapted to display a plurality of types of signals.

6. An airport ground control system as described in claim 1, further comprising a recorder connected to the programmable logic controller that stores all of the input from the detectors and output to the directional signals.

7. An airport ground control system as described in claim 1, further wherein each vehicle on the network is pre-assigned a unique identifier.

8. An airport ground control system as described in claim 2, further wherein each vehicle on the network is pre-assigned a unique identifier.

9. An airport ground control system as described in claim 7, further comprising an alarm that identifies each vehicle on the network that does not have a pre-assigned identifier.

10. An airport ground control system as described in claim 8, further comprising an alarm that identifies each vehicle on the network that does not have a pre-assigned identifier.
